(19) United States
(12) Patent Application Publication
(10) Pub. No.: US 2016/0189057 A1
(43) Pub. Date: Jun. 30, 2016

(54) COMPUTER IMPLEMENTED SYSTEM AND METHOD FOR CATEGORIZING DATA

(71) Applicant: XURMO TECHNOLOGIES PVT. LTD., BENGALURU (IN)

(72) Inventors: VINAY GURURAJA RAO, BENGALURU (IN); SRIDHAR GOPALAKRISHNAN, BENGALURU (IN); SAURABH SANTHOSH, BENGALURU (IN); POOVIAH BALLACHANDA AYAPPA, BENGALURU (IN)

(21) Appl. No.: 14/875,705

(22) Filed: Oct. 6, 2015

(30) Foreign Application Priority Data
Dec. 24, 2014 (IN) 6553/CHE/2014

(51) Int. Cl. G06N 99/00; G06N 5/02; G06F 17/30; G06F 17/27

(52) U.S. Cl. CPC G06N 99/005; G06F 17/2785; G06F 17/277; G06F 17/2775; G06N 5/025; G06F 17/30598

(57) ABSTRACT

A self learning system and a method for categorizing input data have been disclosed. The system includes a generator that generates an initial training set comprising a plurality of words linked to scores/ratings which are based on the sentiments conveyed by the words. The words and corresponding ratings and sentiments are inter-linked and stored in a repository. A rule based classifier segregates the input data into individual words, and compares the words with the entries in the repository, and subsequently determines a first score corresponding to the input data. The input data is also provided to a machine-learning based classifier that generates a plurality of features corresponding to the input data and subsequently generates a second score corresponding to the input data. The first score and the second score are further aggregated by an ensemble classifier which further generates a classification score which enables the data to be classified into a plurality of predetermined categories.

### CROSS REFERENCE TO RELATED APPLICATIONS

This patent application claims the priority of the Indian Provisional Patent Application No. 6553/CHE/2014 filed on Dec. 24, 2014, having the title “SELF-LEARNING METHOD AND SYSTEM FOR ANALYZING DIFFERENT CATEGORIES OR VALUES IN LARGE VOLUMES OF DATA”, and the content of which is incorporated herein by reference in its entirely.

### BACKGROUND

1. Technical Field

The embodiments herein generally relates to data processing. Particularly, the embodiments herein relates to electronic data processing.

2. Description of the Related Art

The Internet includes information on various subjects. This information could have been provided by experts in a particular field or casual users (for example, bloggers, reviewers, and the like). Search engines allow users to identify documents having information on various subjects of interest. However, it is difficult to accurately identify the sentiment expressed by users in respect of particular subjects for example, the quality of food at a particular restaurant or the quality of music system in a particular automobile).

Furthermore, many reviews (or social media or blog content) are long and contain only limited amount of opinion bearing sentences. This makes it hard for a potential customer or service provider to make an informed decision based on the social media content. Accordingly, is desirable to provide a summarization technique, typically a category analysis technique which provides informed opinions about inter-alia different categories of a selected product or service.

Category analysis techniques can be used to assign a piece of text a single value that represents opinion expressed in that text. One problem with existing category analysis techniques is that when the text being evaluated expresses two independent opinions, the category analysis techniques is rendered inaccurate. Another problem with the existing category analysis techniques is that they require extensive rules to ensure an analysis. Yet another problem with the existing category analysis techniques is that they implement machine learning techniques that require a voluminous initial training set. Another problem with existing category analysis techniques is that the sentiment options are not flexible. Yet another problem with the existing category analysis techniques is that, the techniques fails to categorize the data at every level of text granularity i.e. at a word, sentence, paragraph or document level. Yet another problem with the existing category analysis techniques is that these techniques are not self-learning. For at least the aforementioned reasons, improvements in the category analysis techniques techniques are desirable and necessary.

Hence, there was felt a need for a (self-learning) method and system for analyzing and categorizing the input data. Further, there was felt a need for a self-learning method and system which uses an ensemble of rule based approach and machine learning based approach to analyze, and categorize the input data.

The above mentioned shortcomings, disadvantages and problems are addressed herein and which will be understood by reading and studying the following specification.

### Objects of the Embodiments

The primary object of the embodiments herein is to provide a method and system for categorizing the input data.

Another object of the embodiments herein is to provide a method and system for categorizing the input data of different kinds and at different scales as per the user requirements (for example, Positive and Negative sentiment or Bullish and Bearish sentiment or Euphoric, Happy, Neutral, Sad and Depressed sentiment).

Yet another object of the embodiments herein is to provide a self-learning method and system for categorizing the input data irrespective of the language of the input data.

Yet another object of the embodiments herein is to provide a self-learning method and system for categorizing the input data across a collection of structured, unstructured and semi-structured data which is extracted/derived from heterogeneous sources.

Yet another object of the embodiments herein is to provide a self-learning method and system for categorizing the input data using an ensemble of rule based approach and machine learning based approach.

These and other objects and advantages of the embodiments herein will become readily apparent from the following detailed description taken in conjunction with the accompanying drawings.

### SUMMARY

The embodiments herein envisages a computer implemented self-learning system for categorizing input data. The system envisaged by the embodiments herein comprises a generator that generates an initial training set comprising a plurality of words, wherein each of the words is linked to a corresponding score. The generator stores each of the words and corresponding scores, in the form of database entries.

The system further comprises a rule based classifier that receives the input data and extracts a plurality of words therefrom. The rule based classifier compares each of the plurality of words with the database entries and selects amongst the plurality of words, the words being semantically similar to the database entries. The rule based classifier assigns a first score to only those words that exactly match the database entries. The rule based classifier aggregates the first score assigned to each of the words and generates an aggregated first score. Further, the rule based classifier generates a data classification based on at least the words semantically similar to the database entries.

The system further comprises a machine-learning based classifier that receives and processes the input data at d generates a plurality of features corresponding to the input data based on the processing thereof. The machine-learning based classifier further generates a second score corresponding to the input data by processing the features thereof;

The system further includes an ensemble classifier that combines the aggregated first score and the second score, and generates a classification score.

The system further comprises a comparator having access to a predefined threshold value. The comparator compares the first aggregate score with the predefined threshold value and determines whether the first aggregate score is lesser than the predefined threshold value. The comparator thither determines whether the classification score is lesser than the predefined threshold value, only in the event that the first aggregate score is lesser than the predefined threshold value.

The system further comprises a processor that generates a second training set based on only the data classification generated by the rule based classifier only in the event that the first aggregate score is greater than the predefined threshold value. The processor generates the second training set based on only the input data processed by the machine-learning based classifier, in the event that the classification score is greater than the predefined threshold value.

In accordance with the embodiments herein, the rule based classifier further comprises a tokenizer module configured to divide each of the plurality of words into corresponding tokens.

In accordance with the embodiments herein, the rule based classifier further comprises slang words handling module, the slang words handling module configured to identify the slang words present in the input data to be categorized, the slang words handling module thither configured to selectively expand identified slang words thereby rendering the slang words meaningful.

In accordance with the embodiments herein, the rule based classifier is further configured to assign the first score to each of the words segregated from the input, data to be categorized, the rule based classifier further configured to refine the score assigned to each of the words based on the syntactical connectivity between each of the words and a plurality of predetermined negators and intensifiers.

In accordance with the embodiments herein, the machine learning based classifier further comprises a feature extraction module configured to convert the input data into a plurality of n-grams of size selected from the group of sizes consisting of size 1, size 2 and size 3, the feature extraction module further configured to process each of the n-grains as individual features.

In accordance with the embodiments herein, the feature extraction module is further configured to process the input data, and eliminate repetitive words from the input data, the feature extraction module further configured to process and remove stop words from the input data.

In accordance with the embodiments herein, the processor is further configured to instruct the machine learning based classifier to selectively adapt the machine learning algorithms stored thereupon, based on the performance of the machine learning algorithms with reference to the second training set.

The embodiments herein envisage a computer implemented method for categorizing, input data, the method comprising the following computer implemented steps:
generating, using a generator, an initial training set comprising plurality of words, wherein each of the words are linked to a corresponding score;
storing each of the words and corresponding sentiments, in the form of database entries;
extracting a plurality of words from the input data;
comparing, using a rule based classifier, each of the plurality of words with the database entries and selecting amongst the plurality of words, the words being semantically similar to the database entries;
assigning a first score to only those words that exactly match the database entries, and aggregating the first score assigned to each of the words and generating an aggregated first score;
generating a data classification based on at least the words semantically similar to the database entries;
receiving and processing the input data using a machine learning based classifier, and generating a plurality of features corresponding to the input data based on the processing thereof;
processing the features corresponding to the input data and generating a second score;
combining the aggregated first score and the second score using an ensemble classifier, and generating a classification score;
comparing the first aggregate score with a predefined threshold value using a comparator and determining whether the first aggregate score is lesser than the predefined threshold value;
determining whether the classification score is lesser than the predefined threshold value, only in the event that the first aggregate score is lesser than the predefined threshold value; and
generating a second training set based on only the data classification generated by the rule based classifier only in the event that the first aggregate score is greater than the predefined threshold value; and
generating the second training set based on only the input data processed by the machine-learning based classifier, in the event that the classification score is greater than the predefined threshold value.

In accordance with the embodiments herein, the step of extracting a plurality of words from the input data further includes the following steps:
dividing each word of the input data into corresponding tokens;
identifying the slang words present in the input data using a slang words handling module, and selectively expanding identified slang words thereby rendering the slang words meaningful;
assigning, the first score to each of he words segregated from the input data;
selectively refining the score assigned to each of the words based on the syntactical connectivity between each of the words and a plurality of negators and intensifiers; and
ignoring those words of the input data, for which no corresponding semantically similar database entries are present.

In accordance with the embodiments herein, the step of receiving and processing the input data using a machine learning based classifier further includes the following steps:
converting the input data into a plurality of n-grams of size selected from the group of sizes consisting of size 1, size 2 and size 3, and processing each of the n-grams as individual features;
eliminating repetitive words from the input data, and removing stop words from the input data.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating the components of the computer implemented self-learning system for categorizing input text;

FIG. 2 and FIG. 3 in combination illustrate a flow chart describing the steps involved in the computer method for determining the sentiment conveyed by an input text;

FIG. 4 is a flow chart illustrating the steps involved in extracting a plurality of words from the input data;

FIG. 5 is a flow chart illustrating the steps involved in receiving the input text at a machine learning based classifier and processing the input text using said machine learning based classifier.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein envisages a computer implemented, self-learning system for categorizing input data. The system envisaged by the embodiments herein is adapted to analyze/process data gathered from a plurality of sources including but not restricted to structured data sources, unstructured data sources, homogeneous and heterogeneous data sources.

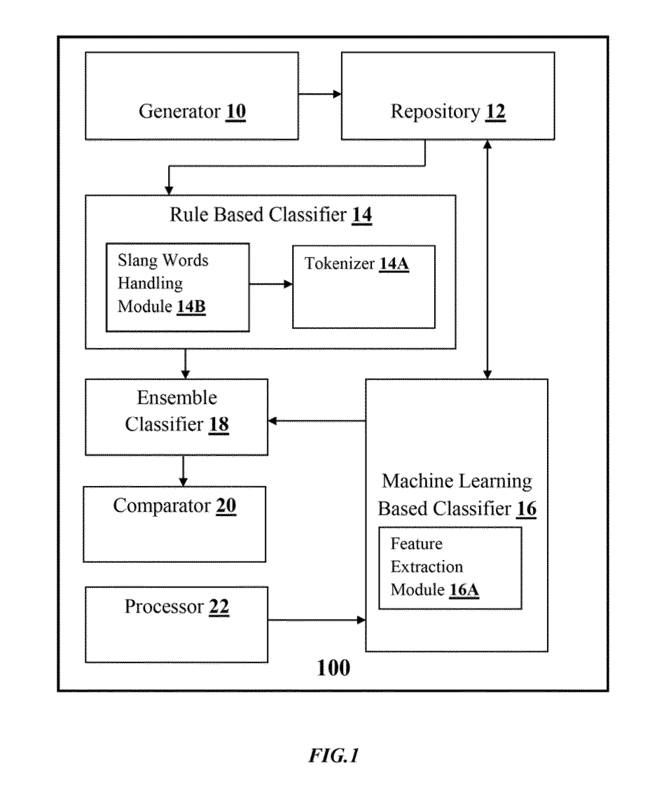

Referring to FIG. 1 of the accompanying drawings, there is shown a computer implemented, self-learning system 100 for categorizing input data. The system 100, in accordance with the embodiments herein comprises a generator 10 configured to generate an initial training set. The initial training set generated by the generator 10 comprises a plurality of words. The generator 10 further associates a score (rating) with each of the words (present in the initial training set) preferably based on the sentiments (for example, ‘happiness’, ‘sadness’, ‘satisfaction’, ‘dissatisfaction’ and the like) conveyed by each of the words. The generator 10 is communicably coupled to a repository 12 which stores each of the words generated by the generator 10, and the first score corresponding to each of the words. Typically, the repository 12 stores an interlinked set of a plurality of words and the corresponding (first) scores.

In accordance with the embodiments herein, the system 100 further includes a rule based classifier 14 configured to receive an input data, the text (typically, a group of words) which needs to be categorized, from a user. The rule based classifier 14 segregates the received input data into a plurality of (meaningful) words. Further, the rule based classifier 14 divides each of the words into respective tokens using a tokenizer module 14A. Further, the rule based classifier 14 comprises a slang handling module 14B configured to remove any slang words from the input data, prior to the input data being fed to the tokenizer module. For example, if the input data comprises a slang word ‘LOL’, the slang handling module 14B expands the slang word ‘LOL’ as ‘Laugh Out Loud’ in order to provide for an accurate analyses of the input data, since the word ‘LOL’ would not typically be included in the repository 12, given that ‘LOL’ is a slang. The rule based classifier 14 further comprises a punctuation handling module 14C for correcting punctuations and a spelling checking module 14D for analyzing a id selectively correcting the spellings in the input data.

In accordance with the embodiments herein, the rule based classifier 14 processes the tokens generated by the tokenizer module 14A, and subsequently compares the words represented by the tokens with the entries in the repository 12. Further, the rule based classifier 14 selects amongst the plurality of (meaningful) words, the words that are semantically similar to the entries in the repository 12. The words (of the input data) that do not have a matching entry in the repository 12 are left unprocessed by the rule based classifier 14.

In accordance with the embodiments herein, the rule based classifier 14 compares each of the words (of the input data) with the semantically similar entries (words) available in the repository, and associates the score corresponding to the word in the repository 12 (entry) to the corresponding semantically similar word of the input data. The rule based classifier 14 further aggregates the first score assigned to each of the plurality of words and generates an aggregated first score. The rule based classifier 14 is further configured to optionally refine the first score assigned to each of the words of the input data, based on the syntactical connectivity between each of the words and based on the presence of negators (for example, ‘never’, ‘do not’, ‘no’) and intensifiers(for example, ‘strongly’, ‘extremely’, ‘very’, ‘absolutely’) in the input data.

In accordance with the embodiments herein, the input data is also fed (provided as input) to a machine learning based classifier 16. In accordance with the embodiments herein, the input data can be simultaneously provided to both the rule based classifier 14 and the machine-learning based classifier 16. The machine learning based classifier 16, in accordance with the embodiments herein generates a plurality of features corresponding to the input data by processing the input data and by treating each word of the input data as an individual feature.

In accordance with the embodiments herein, the machine learning based classifier 16 comprises a feature extraction module 16A configured to convert the input data into a plurality of n-grams of size selected from the group of sizes consisting of size 1, size 2 and size 3. Further, the feature extraction module 16A processes each of the n-grams as individual features. Further, the feature extraction module 16A is configured to process the input data and eliminate repetitive words and ‘stop words’ from the input data.

In accordance with the embodiments herein, the machine learning based classifier 16 implements at least one of Naïve Bayes classification model, Support Vector machines based learning model and Adaptive Logistic Regression based models to process each of the features extracted by the feature extraction module 16A. The machine learning based classifier 16 subsequently produces a second score for the input data, based on the processing of each of the features present in the input data.

In accordance with the embodiments herein, the aggregated first score generated by the rule-based classifier 14 and the second score generated by the machine-learning based classifier 16 are provided to an ensemble classifier 18. The ensemble classifier 18 combines the aggregated first score generated by the rule based classifier 14 and the second score generated by the machine learning based classifier 16, and subsequently generates a classification score corresponding to the input data. Based on the classification score, the system 100 classifies the input data into as belonging to a predetermined category (For example, Positive and Negative OR Bullish and Bearish OR Euphoric, Happy, Neutral, Sad and Depressed).

In accordance with the embodiments herein, the system 100 further includes a comparator 20 configured to compare the aggregated first score and the second score respectively with a predetermined threshold value. The comparator 20 compares the first aggregate score with the predefined threshold value and determines whether the first aggregate score is lesser than the predefined threshold value. The comparator 20 further compares the classification score with the predetermined, threshold value and determines whether the classification score is lesser than the predefined threshold value, only in the event that the first aggregate score is lesser than the predefined threshold value.

In accordance with the embodiments herein, the comparator 20 cooperates with a processor 22. The comparator 20 instructs the processor 22 to generate a second training set based on only the data classification generated by the rule based classifier 14 only in the event that the first aggregate score is greater than the predefined threshold value. The comparator 20 instructs the processor 22 to generate the second training set based on only the input data processed by the machine-learning based classifier 16, in the event that the classification score is greater than the predefined threshold value. The training sets generated by the processor 22 are typically used to modify the machine learning models stored in the machine learning based classifier 16.

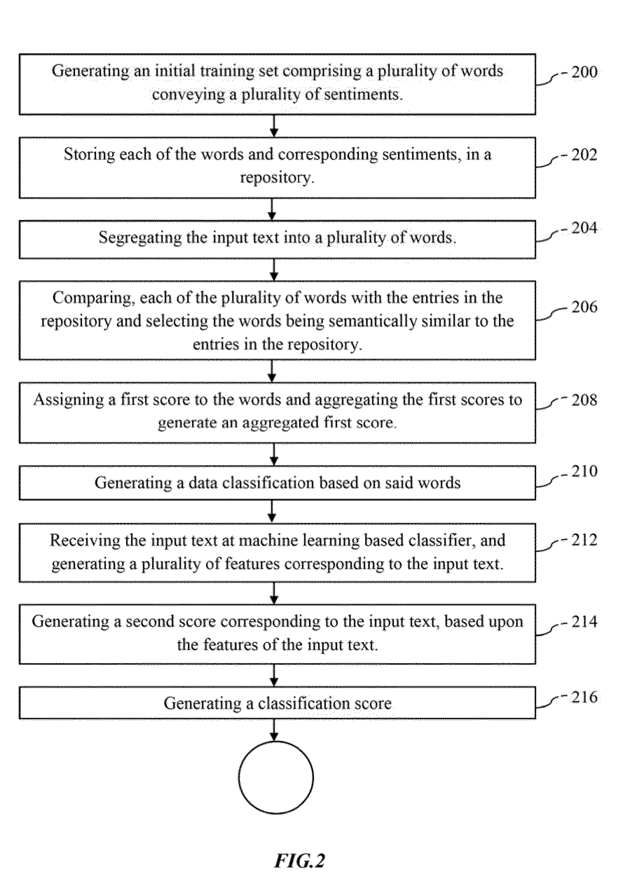

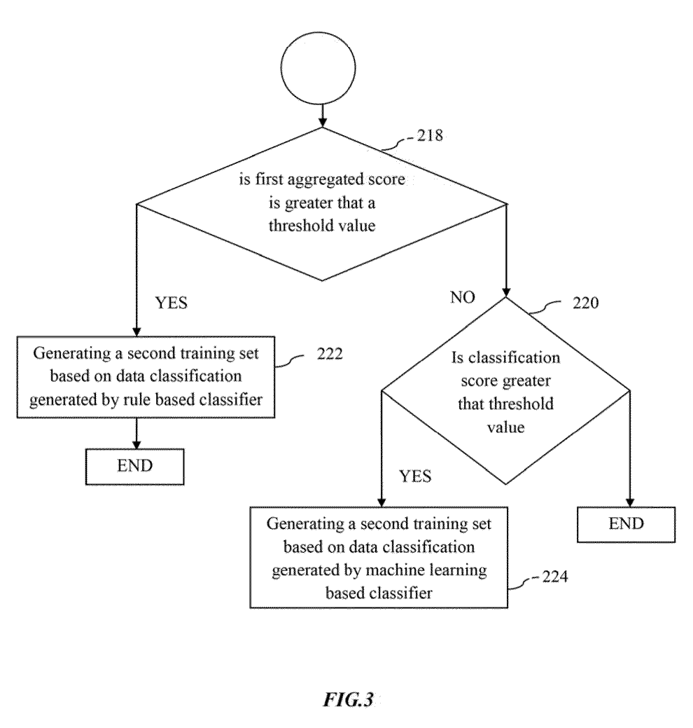

Referring, to FIG.2 and FIG.3, there is shown a flow chart illustrating the steps involved in the computer-implemented method for categorizing data. The method, in accordance with the embodiments herein includes the following steps:
generating, using a generator, an initial training set comprising a plurality of words, wherein each of said words are linked to a corresponding score (200);
storing each of said words and corresponding sentiments, in the form of database entries (202);
extracting a plurality of words from the input data (204);
comparing, using a rule based classifier, each of said plurality of words with the database entries and selecting amongst the plurality of words, the words being semantically similar to the database entries (206);
assigning a first score to only those words that exactly match the database entries, and aggregating the first score assigned to each of said words and generating an aggregated first score (208);
generating a data classification based on at least the words semantically similar to the database entries (210);
receiving and processing the input data using a machine learning based classifier, and generating a plurality of features corresponding to the input data based on the processing thereof (212);
processing the features corresponding to the input data and generating a second score (214);
combining the aggregated first score and the second score using an ensemble classifier, and generating a classification score (216);
comparing said first aggregate score with a predefined threshold value using a comparator and determining whether the first aggregate score is lesser than the predefined threshold value (218);
determining whether the classification score is lesser than the predefined threshold value, only in the event that the first aggregate score is lesser than the predefined threshold value (220);
generating a second training set based on only the data classification generated by the rule based classifier only in the event that the first aggregate score is greater than the predefined threshold value (222); and
generating the second training set based on only the input data processed by the machine-learning based classifier; in the event that the classification score is greater than the predefined threshold value (224).

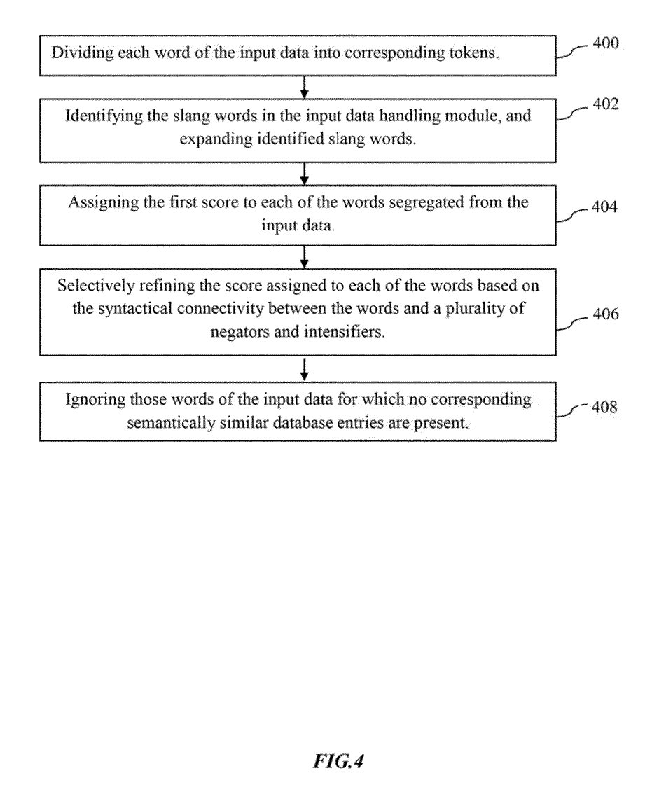

In accordance with the embodiments herein, FIG. 4 describes the steps involved in extracting a plurality of words from the input data:
dividing each word of the input data into corresponding tokens 400;
identifying the slang words present in the input data using a slang words handling module, and selectively expanding identified slang words thereby rendering the slang words meaningful 402;
assigning, the first score to each of the words segregated from the input data 404;
selectively refining the score assigned to each of said words based the syntactical connectivity between each of said words and a plurality of negators and intensifiers 406; and
ignoring those words of the input data, for which no corresponding semantically similar database entries are present 408.

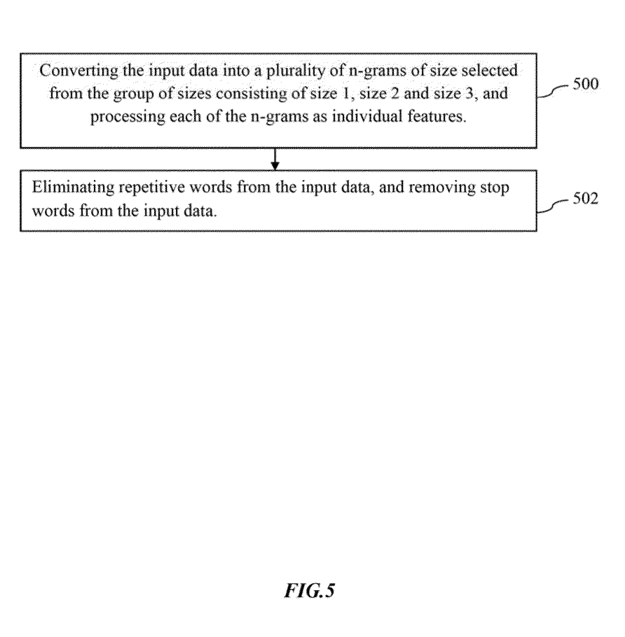

In accordance with the embodiments herein, FIG. 5 illustrates the steps involved in receiving and processing the input data using a machine learning based classifier:
converting the input data into a plurality of n-grams of size selected from the group of sizes consisting of size 1, size 2 and size 3, and processing each of the n-grams as individual features 500;
eliminating repetitive words from the input data, and removing stop words from the input data 502.

The embodiments herein envisages a system and method for categorizing the input data. The system envisaged by the embodiments herein incorporates an ensemble of classification models which are rendered capable of self learning. The said ensemble includes two different norms of the classification models, one of the models is a rule based classifier model and the other model is a machine teaming based classifier model. The rule-based classifier needs a set of dictionaries to initiate data processing, and the machine-learning based classifier requires sufficient amount of data to create a classification model. The embodiments herein creates an ensemble of the rule-based classifier model and machine-learning-based classifier model to provide for an accurate determination of the category of the input data.

The system envisaged by the embodiments herein is a self-learning and hence self-improving system

The system envisaged by the embodiments herein does not require a voluminous initial training set for Machine learning since the self-learning system provides a constant feedback in respect of the processed text/data.

The Rule based classifier also evolves itself by consuming a training set. The Rule based classifier refines the score, and automatically identifies and refines the threshold value for classification based on the training sets.

The system envisaged by the embodiments herein incorporates the flexibility to determine different types of categories and at different scales as per user requirements (e.g. Positive and Negative sentiment OR Bullish and Bearish sentiment OR Euphoric, Happy, Neutral, Sad and Depressed sentiment).

The system envisaged by the embodiments herein categorizes the input data irrespective of the level of text granularity i.e. at a word level, sentence level, paragraph level and document level.

The self-learning system of the embodiments herein is language independent. Even the languages written in different scripts (for example, Hindi language comments written in English script) can be appropriately classified by using an appropriate dictionary and training set.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A computer implemented self-learning system for categorizing input data, said system comprising:
a generator configured to generate an initial training set comprising a plurality of words, wherein each of said words are linked to a corresponding sentiment, said generator still further configured to store each of said words and corresponding sentiment, in the form of database entries;
a rule based classifier cooperating with said generator, said rule based classifier configured to receive the input data and extract a plurality of words therefrom, said rule based classifier still further configured to compare each of said plurality of words with the database entries and select amongst the plurality of words, the words being semantically similar to the database entries, said rule based classifier still further configured to assign a first score to only those words that exactly match the database entries, said rule based classifier further configured to aggregate the first score assigned to each of said words and generate an aggregated first score, said rule based classifier still further configured to generate a data classification based on at least the words semantically similar to the database entries;
a machine-learning based classifier cooperating with said generator, said machine learning based classifier configured to receive and process the input data, said machine learning based classifier further configured to generate a plurality of features corresponding to the input data based on the processing thereof, and generate a second score corresponding to the input data by processing the features thereof;
an ensemble classifier configured to combine the aggregated first score and the second score, and generate a classification score;
a comparator having access to a predefined threshold value, said comparator configured to compare said first aggregate score with the predefined threshold value and determine whether the first aggregate score is lesser than the predefined threshold value, said comparator still further configured to determine whether the classification score is lesser than the predefined threshold value, only in the event that the first aggregate score is lesser than the predefined threshold value; and
a processor cooperating with the comparator, said processor configured to generate a second training set based on only the data classification generated by the rule based classifier only in the event that the first aggregate score is greater than the predefined threshold value, said processor further configured, to generate the second training set based on only the input data processed by the machine-learning, based classifier, in the event that the classification score is greater than the predefined threshold value

2. The system as claimed in claim 1, wherein said rule based classifier further comprises a tokenizer module configured to divide each of the plurality of words into corresponding tokens.

3. The system as claimed in claim 1, wherein said rule based classifier further comprises slang words handling module, said slang words handling module configured to identify the slang words present in the input data to be categorized, said slang words handling module further configured to selectively expand identified slang words thereby rendering the slang words meaningful.

4. The system as claimed in claim 1, wherein said rule based classifier is further configured to assign the first score to each of the words segregated from the input data to be categorized, said rule based classifier further configured to refine the score assigned to each of said words based on the syntactical connectivity between each of said words and a plurality of predetermined negators and intensifiers.

5. The system as claimed claim 1, wherein said machine learning based classifier further comprises a feature extraction module configured to convert the input data into a plurality of n-grams of size selected from the group of sizes consisting of size 1, size 2 and size 3, said feature extraction module further configured to process each of the n-grams as individual features.

6. The system as claimed in claim 5, wherein said feature extraction module is further configured to process the input data, and eliminate repetitive words from the input data, said feature extraction module further configured to process and remove stop words from the input data.

7. The system as claimed in claim 1, wherein the processor is further configured to instruct said machine learning based classifier to selectively adapt the machine learning algorithms stored thereupon, based on the performance of said machine learning algorithms with reference to the second training set.

8. A computer implemented method for categorizing input data, said method comprising the following computer implemented steps:
generating, using a generator, an initial training set comprising a plurality of words, wherein each of said words are linked to a corresponding score;
storing each of said words and corresponding sentiments, in the form of database entries;
extracting a plurality of words from the input data;
comparing, using a rule based classifier, each of said plurality of words with the database entries and selecting amongst the plurality of words, the words being semantically similar to the database entries;
assigning a first score to only those words that exactly match the database entries, and aggregating the first score assigned to each of said words and generating an aggregated first score;
generating a data classification based on at least the words semantically similar to the database entries;
receiving and processing the input data using a machine learning based classifier, and generating a plurality of features corresponding to the input data based on the processing thereof;
processing the features corresponding to the input data and generating a second score;
combining the aggregated first score and the second score using an ensemble classifier, and generating a classification score;
comparing said first aggregate score with a predefined threshold value using a comparator and determining whether the first aggregate score is lesser than the predefined threshold value;
determining whether the classification score is lesser than the predefined threshold value, only in the event that the first aggregate score is lesser than the predefined threshold value; and
generating a second training set based on only the data classification generated by the rule based classifier only in the event that the first aggregate score is greater than the predefined threshold value; and
generating the second training set based on only the input data processed by the machine-learning based classifier, in the event that the classification score is greater than the predefined threshold value.

9. The method as claimed in claim 8, wherein the step of extracting a plurality of words from the input data further includes the following steps:
dividing, each word of the input data into corresponding tokens;
identifying the slang words present in the input data using a slang words handling module, and selectively expanding identified slang words thereby rendering the slang words meaningful;
assigning the first score to each of the words segregated from the input data;
selectively refining the score assigned to each of said words based on the syntactical connectivity between each of said words and a plurality of negators and intensifiers; and
not assigning a score those words of the input data, for which no corresponding semantically similar database entries are present.

10. The method as claimed in claim 8, wherein the step of receiving and processing the input data using a machine learning based classifier further includes the following steps:
converting the input data into a plurality of n-grams of size selected from the group of sizes consisting of size 1, size 2 and size 3, and processing, each of the n-grams as individual features;
eliminating repetitive words from the input data, and removing stop words from the input data.
